(19) United States
(12) Patent Application Publication
(10) Pub. No.: US 2007/0022113 A1
(43) Pub. Date: Jan. 25, 2007

(54) Systems and methods for automation of employment matching services

(76) Inventor: Jay J. Heino, Woodmere, NY (US)

Correspondence Address: MOAZZAM & ASSOCIATES, LLC, 7787 LEESBURG PIKE, SUITE 200, FALLS CHURCH, VA, 22043, US

(21) Appl. No.: 11/186,765

(22) Filed: Jul. 22, 2005

(51) Int. Cl. G06F 17/30

(52) U.S. Cl. 707/6

(57) ABSTRACT

The present invention discloses systems and methods for automation of matching between employers and employees. The automation is made efficient and accurate by matching a desired set of attributes for a given profession as expressed by an employer with a database of personal and technical attributes by professionals either in such a position or desiring to be in such a profession. Potential employers or employees may be immediately alerted to the availability of a match thereby decreasing the time required to search and provide direct information to the other.

### BACKGROUND OF THE INVENTION

1. Field of the Invention

The present invention relates to automation of employment matching services. More particularly, the present invention relates to systems and methods for matching potential employees with employers seeking employees based on a specific set of mutual attributes.

2. Background of the Invention

Considerable cost is expended each year by employers in search of “the right” employees or employees searching, seeking and finding an employer that best suits the employees' interests. This cost is typically even higher for professional employers searching for employees with special talents, backgrounds or interests. For example, such employers can only typically advertise in special journals or magazines, participate in job fairs or hire professional recruiters to seek such employees. All such options result in considerable cost without any assurance that the potential employee or job seeker that is interviewed will be the right fit for the employer.

Traditionally, a potential job seeker seeking employment sends out a number of resume packets to a number of employers in various cities, as shown in FIG. 1A. This approach is very common especially for new potential job seekers seeking that first job, as is typical for college graduates or recent professional school graduates. Such “shotgun” approach to seeking employment results in a high volume of mailings and with typically minimum return of interest by the employer recipients of such resumes. Potential job seekers are aware of the relatively low likelihood of success using this shotgun approach so they tend to mail out a very large volume of resume packets. Once the resume packets are sent out, there is usually a large delay of time before a recipient employer has a chance of reviewing the resume packet and contacting the job seeker. A common response is a letter from the employer that the resume was received and will be filed away for future consideration. Another common response is that the qualifications of the job seeker are not in par with what the employer desires.

Such shotgun approaches are costly and inefficient, from both the perspectives of the job seeker and the employer. The job seeker is forced to spend an inordinate amount of time seeking potential employers that may hopefully consider the job seeker, and then must incur additional expenses preparing the resume packets and sending them out to the potential employers. The employer, in turn, must maintain a human resources department or designated staff to consider all of the resume packets that arrive at the employer's office, and filter through them to consider if the information provided in the resume packets somewhat resembles the needs of the employer. Certain employers receive a very large volume of resume packets, especially near the end of the school season, thereby resulting in additional expenses to consider the extra volume as well as the additional delay in time from handling the larger volume. Even more, by the time such an employer recognizes that one of the resume packets fits the profile of a needed potential employee, the job seeker may have already interviewed or accepted offers from other more efficient employers.

Another conventional method of matching employers with potential employees is through the use of an executive recruiter or “headhunter,” as used interchangeably herein, and as shown in FIG. 1B. A professional headhunter typically works for an employer in searching for an employee with a given set of talents or a desired educational or professional experience. Such executive recruiters or headhunters are well versed with the desires of the employer because of their direct communication. However, their ability to seek out the perfect candidate(s) is limited by their knowledge of available professionals in that particular field, or by their ability to research to find such professionals. Even if a headhunter has an extensive library of individuals, he may not know or have information about particular attributes that an employer is seeking in a new candidate. Thus, the headhunter is resorted to having to contact the individual candidates and further inquire about their perspective or experience with respect to the particular attribute(s). This results in higher costs for the headhunter (and employer), as well as additional time and research.

Yet another conventional method of matching employers and employees is a relatively new concept involving an on-line or automated resume posting and searching services, an example of which is shown in FIG. 1C. In such services, a large number of employees typically post their resume under certain general headings and anticipate future contact by employers who perform generalized key word searches that seek certain employees with certain qualities or attributes.

For example, a tax attorney may only be able to post his resume under the “attorney” heading and hope that certain words that he uses are the ones that a law or accounting firm or corporation uses when seeking out potential tax attorneys. If the law or accounting firm or corporation were seeking tax attorneys that have particular experience in non-profit religion-based organizations, it would be merely coincidence that would link a certain tax attorney's resume with the search by that particular potential employer. It may be that there are many other tax attorneys that not only are well experienced in such specialized organizations, but also would be very open to seeking such a position. However, their resumes were made broad to appeal to a larger audience of potential employers. Thus, the right connection was unable to be made because the job seeker did not use the right words in his resume that the employer had used as keywords when seeking out potential employees. Furthermore, if a potential employer is interested in a job seeker's perspective on a very specific point, such as, for example, desire for travel in business, then there would be no way for such employer to glean such information from the mass postings of hundreds of resumes. Conversely, the employer could be gathering resumes that have nothing to do with their desired search for a particular candidate just because such resumes include the word “travel” somewhere within it, such as, for example, under the general “interests” section. Finally, many such resumes may have become out of date because the job seeker is no longer searching for a position, and conversely, the employee could be responding to a job positing that has already been filled but the employer may not have removed it from the web positing. Additionally, such massive web job posting sites do not take into account that there are many individuals who may not otherwise seek other employment or post their resumes on such a site, but would be open to a particular position for a given employer if they were aware or made aware that such a position is available.

Thus, a need exists in the art for an alternative to the conventional methods of attempting to match job seekers with employers, which typically result in additional expenditure of time and money, for both the job seeker and the employer. Furthermore, such alternative should overcome the problems inherent in conventional methods by streamlining the matching process as well as decreasing the costs associated with such matching. Additionally, such alternative should result in an efficient and more precise way of connecting an employer looking for very specific attributes in an employee with a job seeker that shows particular strength, experience or desire in such attributes, anywhere in the world.

### SUMMARY OF THE INVENTION

The present invention provides an alternative and enhancement to conventional systems and methods for matching employers and employees through use of mass mail resumes, headhunters or web site mass job posting sites. The present invention involves storing a library of information relating to the attributes of job seekers. Such attributes include the particular experiences, educational backgrounds, desires and interests of a job seeker in an ideal new position. Such attributes necessarily differ between career positions and are dependent on the type of position as well as the experience of the job seeker. The set of attributes known or stored about a particular job seeker is typically more complete than particular attributes that a given potential employer is seeking. Potential employers then express their interest in obtaining employees with a particular set of attributes, optionally including the importance of some attributes over others. The present invention considers the desired attributes as expressed by the potential employer and matches it with the known attributes of a library of potential employees within that career heading, and further ranks the importance expressed by the employer in determining the rankings of attributes to result in a list of potential employees that best match the interests of the employers as a result of matching of desired attributes by the employer with personal and technical attributes of an employee. Such list may be further considered by a recruiting professional (e.g., headhunter) before being passed on to the employer or may be passed directly to the employer through various means of communication. The present invention is a less expensive, more efficient and more accurate way of matching the needs of an employer seeking a new employee with particular attributes, and the potential candidates that have such attributes, whether they are active job seekers or not.

In one exemplary embodiment, the present invention is a system for matching employers and potential candidate employees. The system includes a database for receiving a set of desired attributes for a particular position offered by an employer and a set of personal and technical attributes from one or more potential candidates for the position; and a processor in communication with the database to compare the desired attributes with the personal and technical attributes and sort and rank the potential candidates in terms of match with the desired attributes.

In another exemplary embodiment, the present invention is a method for matching employers and potential candidate employees. The method includes considering a list of desired attributes for a particular position offered by an employer; comparing the list of desired attributes with personal and technical attributes from a database of potential candidates; and ranking candidates in order of match according to the degree of similarity of their personal and technical attributes as compared with the desired attributes of the employer.

In yet another exemplary embodiment, the present invention is a method for matching employers seeking tax attorneys with potential candidates. The method includes considering a list of desired attributes for a tax attorney position offered by an employer; comparing the list of desired attributes with personal and technical attributes from a database of tax attorneys; and ranking the tax attorneys in order of match according to the degree of similarity of their personal and technical attributes as compared with the desired attributes of the employer.

### BRIEF DESCRIPTION OF THE DRAWINGS

FIG. 1A shows a conventional strategy of seeking employment by using a “shotgun” mass mailing of resume packets to a potentially large number of potential employers.

FIG. 1B shows a conventional strategy of using a headhunter to serve as the matchmaker between an employer and an employee.

FIG. 1C shows a conventional job posting web site that includes a large database of resumes that employers can access using, for example, key words, to search for certain qualifications that may be printed on the resume.

FIG. 2 shows a system and method according to an exemplary embodiment of the present invention where potential employers and potential candidates are linked by categorized database that provides a match to a headhunter by comparison of the desired and personal attribute sets.

FIG. 3 shows another exemplary embodiment according to the present invention where the connection between employers and employees are completely automated with minimal to no input from a headhunter.

FIG. 4 shows yet another exemplary embodiment of the present invention where information is sent to employers and candidates in real time using various means to reach the interested parties in an expedited manner.

### DETAILED DESCRIPTION OF THE INVENTION

The present invention provides systems and methods for matching employees with certain personal (e.g., talents, experiences, education, desires, etc.) and technical (e.g., given certification or knowledge in certain science, technology, law, business sector, etc.) attributes with employers who are specifically seeking such attributes in a new employee in an efficient, automated and cost-effective manner.

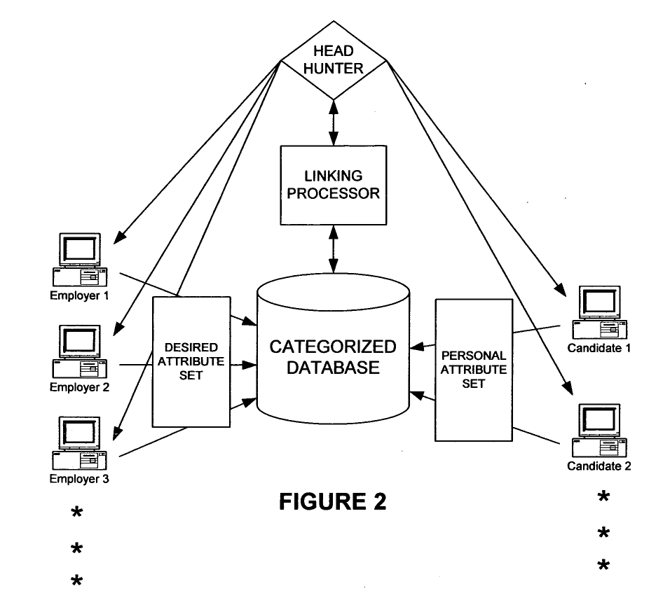

An exemplary embodiment of the present invention is shown in FIG. 2. In this exemplary figure, potential employers 1, 2, 3 provide a set of specific attributes that they deem important for a particular new employee that they are seeking. Such specific attributes may be received from the employer in response to a questionnaire or other inquiry that receives and triages such information according to what the employer deems is the order of importance. For example, an employer may seek a tax attorney with experience (or desire) in working with non-profit religion-based organizations and who also has desire to travel for business. The employer considers desire for such a position as more important than prior experience. It may be possible to find a few candidates that have some experience working with non-profit religion-based organizations. However, it is very difficult to almost impossible to consider a potential candidate's desire to work with non-profit organizations, let alone the candidate's desire to travel for business. Such information is not typically (or ever) listed on a resume. However, the present invention alleviates the problems associated with situations such as this by filling in a need for such employers to seek job candidates with such attributes, including desires for certain aspects that may seldom or never be listed on a resume. Such a technique allows an employer to seek such critical attributes in a candidate before having to incur the cost of bringing in a candidate to an interview, only to find out then that the candidate does not possess such critical attributes.

In a similar manner as with potential employers, potential candidates are asked certain questions that relay their attributes (e.g., experience, qualities and personal preferences) to the same system that also considers the requirements and desires of the employer. All such information from both the potential employers and the candidates are stored in a categorized database that optionally lists careers by major category. Such an example of a major career listing could be, for example, “tax attorneys.”

The desires of the employer in terms of specific attributes are matched with a database of information relating to the responses from a list of employees using a linking processor that considers the specific attributes that the employer seeks with how a potential candidate answered to and/or ranked such attributes. A list of non-limiting examples of such attributes, include, but are not limited to: educational background, universities attended, job experience at particular major accounting firms, experience with specific areas of tax law (non-profit, corporation, small companies, etc.), desire for business travel, vacation days sought, salary range, and the like. Furthermore, each such attribute may be ranked in terms of importance. Each such attribute could be further considered by one or more questions in the questionnaire provided to the potential candidate.

The system according to the present invention determines which of the major attributes that the employer has sought is most common or applicable to which one(s) of the potential candidates in the database. If a large number of potential candidates are available, then the system can also rank such candidates in order of “match power,” in that the employer and employee consider certain attributes as more important than others. The system can then provide a list with the order of candidates according to the best fit. If and when such matches are made, then the system may relay such matches to a headhunter, system manager or other similar personnel, who then can reconsider the particular attributes sought by a potential employer and the particular personal and technical attributes of the potential candidate(s). This additional “human touch” may be necessary to reconfirm that the linking processor has properly matched the desires of the potential employer with the personal and technical attributes of a given list of employees. Such process also allows a further narrowing of the candidate list if necessary. Alternatively, the headhunter may forward the entire list directly to the employer, allowing the employer to further consider the attributes of its potential candidate list before deciding to pursue any one or more candidates for an interview, etc.

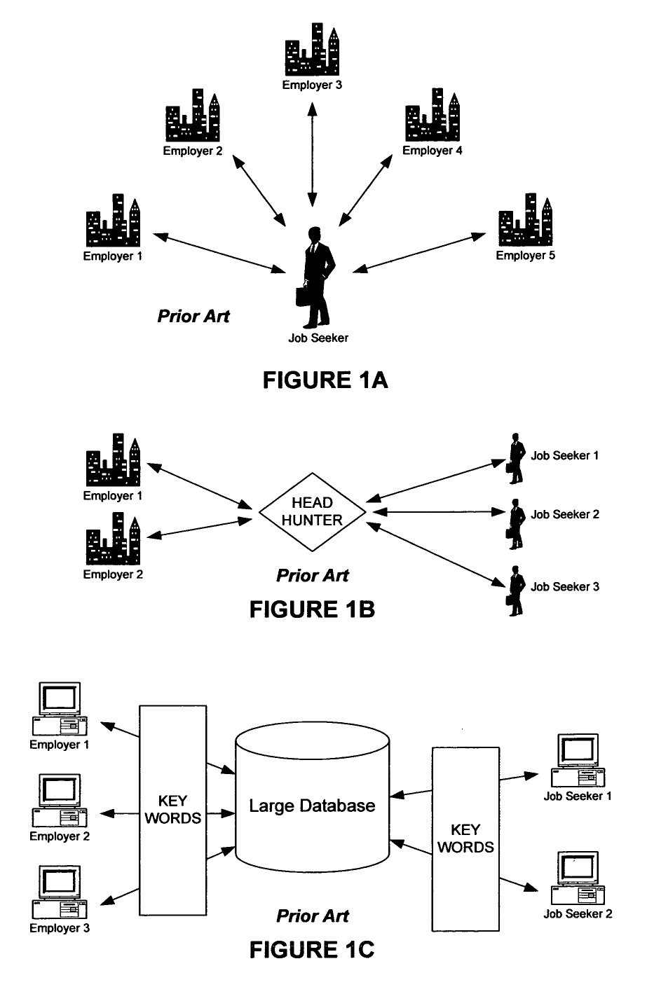

Although the above example with respect to FIG. 2 was described with respect to a potential employer seeking candidate employees, the present invention is not limited to this scenario. Optionally, the employee may be provided a list of potential employers by the headhunter that are either actively seeking or have historically sought employees that have the attributes of the employee. In this optional scenario, the system according to the present invention has considerably decreased the search time and expense for a job seeker searching for employment who, otherwise, may have had to resort to the shotgun method described and shown in FIG. 1A. Thus, such a system and method according to the present invention decreases or eliminates the manpower and associated costs needed to consider a large volume of resumes, either directly by the employer company itself or by a headhunting or similar employee search company.

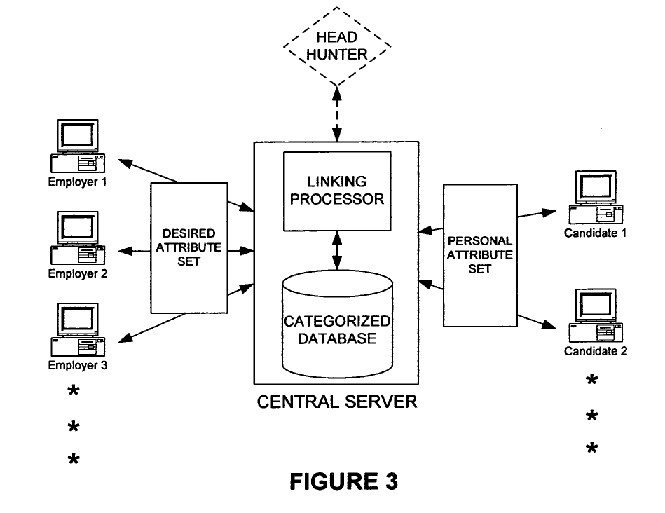

In another exemplary embodiment of the present invention, as shown in FIG. 3, the system may be made to be completely automated, requiring minimal to no human intervention. In this exemplary embodiment, potential employers and potential candidates all provide information relating to their attribute list to a central server. Such a server may be a remote server that is accessible by the Internet and further includes a database and linking processor, similar to that described for the exemplary embodiment shown in FIG. 2. The central server allows for the desired attribute set to be received from the potential employer, and such attribute set to be compared with the database of candidate responses to such specific attributes. After a match is made (or if no match is possible at this time), the central server directs information relating to the match back to the potential employer through, for example, the human resources manager and/or the employee specifically tasked with finding such a candidate. The employer then considers the list of potential candidates and can then further filter some candidates out depending on their answers to some questions or can seek to reach out and inquire for additional information or offer interviews to certain candidates. Alternatively, the exemplary system may be used by a potential candidate in seeking out employers with specific attributes seeking such a candidate. Either way that the system is used, its use results in considerable financial and time savings. Finally, a headhunter or system manager may supervise the operation for quality assurance purposes or, alternatively, if such supervision is specifically requested by the party seeking such an inquiry.

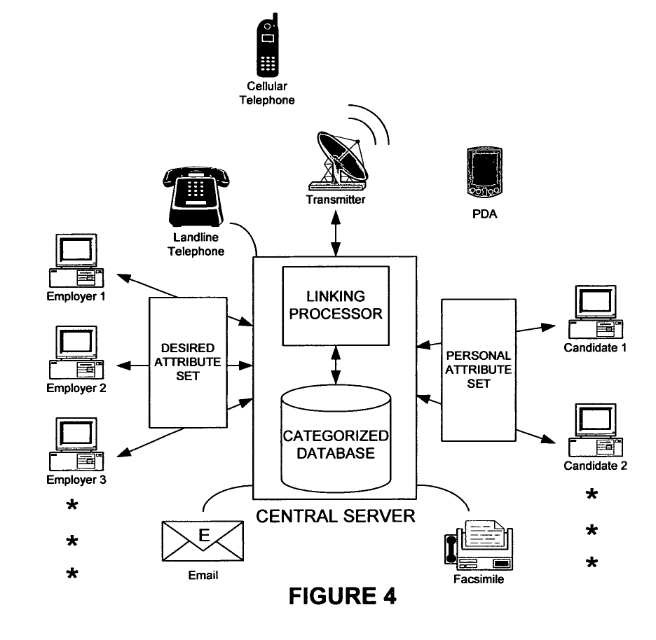

A particular desirous employee candidate may be sought out by many different potential employers. Often times, luck plays a large part in a particular employer “landing” such a desirous employee, either through a mutual contact or other non-traditional route. The same scenario is also true in reverse, in that a particularly desirous position is secured by a potential candidate through a stroke of luck by the candidate or by some level of desperation on the part of the employer in seeking to find an immediate fill of such a position. In either of the scenarios, the employee filling the position may not be the best qualified or desired for such a position. However, because of the costs involved in seeking and considering a large number of employees for a given position, it was necessary to curtail the search process. Thus, there is a further need in the art to provide real time information relating to available positions or candidates to employers and/or employees so that all members of such a system would have an equal chance of “landing” such a desirable position or having an opportunity to hire a very strong candidate. Such an exemplary system according to the present invention is shown in FIG. 4.

In FIG. 4, an exemplary system is shown that has the ability to provide real time information to employers and/or employees regarding immediately available candidates and/or positions, respectively. The central server functions in much the same manner as that shown and described with respect to FIG. 3. Furthermore, the central server in FIG. 4 is programmed to immediately communicate with members of the system upon determination of a match by the linking processor. Such information may be immediately relayed to members through land lines, such as telephones, facsimiles or email, or through wireless devices accessed through a transmitter, such as cellular telephones, pagers, personal data assistants (PDA), a BLACKBERRY™ (RIM) or the like.

The system shown in FIG. 4, in use, provides an immediate message to all members (employers, employees, headhunters, etc.) who have previously indicated a desired set of attributes. For example, consider an example of a corporation that has sought but has been unsuccessful in finding a very specialized tax attorney with the following set of attributes: from a top 5 accounting firm; a CPA; an Ivy League education; and with prior experience and current desire to work with the health care industry. It may happen that the same attributes are in high demand and other corporations are also desiring a candidate with similar if not exactly the same attributes. In another part of the country, a candidate fitting such an attribute profile is seeking to leave the accounting firm for which he works and work for a corporation. Such a candidate connects into the system shown in FIG. 4 by answering the questionnaire made specific for his career field of “tax attorneys.” Upon completion of the online form, which included questions specifically seeking information relating to the desired attributes of the corporations, the linking processor considers the personal and technical attributes of the candidate and makes an immediate match to a number of corporations seeking such a candidate. Immediately, the central server sends out messages in the pre-designated communication format to each corporation that has asked for an immediate alert once such a candidate is available. For example, personnel directors or other such human resources managers would receive such alerts. The next step would be to immediately consider and contact such a candidate to inquire further and/or request an interview. Alternatively, the system may be set up so that any contact to the potential candidate would have to be made through the executive searcher or headhunter. Thus, from the moment that the candidate has completed the questionnaire and sent all information, it may be mere minutes before a human resources manager or hiring executive at a desired corporation receives alert of the availability of such a candidate and contacts the candidate directly (or indirectly through an intermediary) to proceed further. Such a system and method decreases costs associated with seeking and searching for new matches between employers and employees as well as providing increased efficiency and accuracy in completing such matches. The employee has spent a nominal amount of time answering questions regarding his personal and technical attributes, and was immediately contacted by employer(s) who have sought such attributes. Considerable time and money has been saved by all parties involved.

The systems and methods described in the examples herein used a general description of attributes to match the employer and potential employee. It should be noted that the employer (and/or employee) has the ability to designate which attributes are more important than others. Also, such a system and method may be created using one or more off-the-shelf software in conjunction with a generally accessible medium (such as an Internet web site) to allow both employers and employees to provide information relating to the candidates or positions they seek, respectively.

Furthermore, the invention was described using tax attorneys as an example. However, the invention is not limited to such profession. The questionnaire that absorbs the necessary attributes for a given potential candidate should be made specific to the particular career position that a candidate is seeking. For example, a position for a police officer would and should have a different attribute questionnaire than a tax attorney. Each profession has its own set of separate and distinct attributes. The present invention may be made to have questionnaires that are specific to a variety of professions so that the specific attributes of each type of profession are considered separately.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, the database could contain attributes of a large number of professionals who are not necessarily currently looking for new positions, but could be open to a new employer if one approached the professional. For a professional headhunter or executive searcher, such a match between a desired set of attributes by an employer and the resulting match to several candidates (even if not actively seeking new jobs) would considerably cut down the search time. It may be that the candidate may actually consider the position if approached. These and other scenarios are apparent to one having ordinary skill in the art. The invention is not limited to the examples presented herein. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for matching employers and potential candidate employees, the system comprising:
a database for receiving a set of desired attributes for a particular position offered by an employer and a set of personal and technical attributes from one or more potential candidates for the position; and
a processor in communication with the database to compare the desired attributes with the personal and technical attributes and sort and rank the potential candidates in terms of match with the desired attributes.

2. The system of claim 1, further comprising means to notify the employer of one or more matches with potential candidates.

3. The system of claim 2, wherein the notification means provides immediate contact with the employer.

4. The system of claim 2, wherein the notification means provides information relating to the candidates to an intermediary who is then contacted by interested employers who desire to communicate with the candidates.

5. The system of claim 1, further comprising means to notify the candidates of one or more matches with potential employers.

6. The system of claim 5, wherein the notification means provides immediate contact with the candidates.

7. The system of claim 5, wherein the notification means provides information relating to the employers to an intermediary who is then contacted by interested candidates who desire to communicate with the employers.

8. A method for matching employers and potential candidate employees, the method comprising:
considering a list of desired attributes for a particular position offered by an employer;
comparing the list of desired attributes with personal and technical attributes from a database of potential candidates; and
ranking candidates in order of match according to the degree of similarity of their personal and technical attributes as compared with the desired attributes of the employer.

9. The method of claim 8, further comprising:
communicating with the employer with information about one or more matches with potential candidates.

10. The method of claim 9, wherein the communication step occurs in real time as soon as a match is made.

11. The method of claim 9, wherein the communication step provides information relating to the candidates to an intermediary who is then contacted by interested employers who desire to communicate with the candidates.

12. The method of claim 8, further comprising:
communicating with the candidate with information about one or more matches with potential employers.

13. The method of claim 12, wherein the communication step occurs in real time as soon as a match is made.

14. The method of claim 12, wherein the communication means provides information relating to the employers to an intermediary who is then contacted by interested candidates who desire to communicate with the employers.

15. A method for matching employers seeking tax attorneys with potential candidates, the method comprising:
considering a list of desired attributes for a tax attorney position offered by an employer;
comparing the list of desired attributes with personal and technical attributes from a database of tax attorneys; and
ranking the tax attorneys in order of match according to the degree of similarity of their personal and technical attributes as compared with the desired attributes of the employer.

16. The method of claim 15, further comprising:
communicating with the employer with information about one or more matches with potential tax attorney candidates.

17. The method of claim 16, wherein the communication step occurs in real time as soon as a match is made.

18. The method of claim 16, wherein the communication step provides information relating to the candidates to an intermediary who is then contacted by interested employers who desire to communicate with the candidates.

19. The method of claim 15, further comprising:
communicating with the candidate with information about one or more matches with potential employers.

20. The method of claim 19, wherein the communication means provides information relating to the employers to an intermediary who is then contacted by interested candidates who desire to communicate with the employers.
